(19) United States
(12) Patent Application Publication
(10) Pub. No.: US 2022/0157174 A1
(43) Pub. Date: May 19, 2022

(54) INFORMATION PROCESSING DEVICE, INFORMATION PROCESSING METHOD, AND SYSTEM

(71) Applicant: TOYOTA JIDOSHA KABUSHIKI KAISHA, Toyota-shi Aichi-ken (JP)

(72) Inventors: Osamu Izumida, Nagoya-shi (JP); Mitsuhiro Miura, Okazaki -shi (JP); Xin Jin, Nagoya-shi (JP); Genshi Kuno, Kasugai-shi (JP)

(73) Assignee: TOYOTA JIDOSHA KABUSHIKI KAISHA, Toyota-shi Aichi-ken (JP)

(21) Appl. No.: 17/528,389

(22) Filed: Nov. 17, 2021

(30) Foreign Application Priority Data
Nov. 19, 2020 (JP) 2020-192862

(51) Int. Cl. G08G 1/00; G06Q 10/06; G06Q 10/02; G06Q 50/30; G06K 9/00

(52) U.S. Cl. CPC G08G 1/202; G06Q 10/06315; G06K 9/00362; G06Q 50/30; G06K 9/00335; G06Q 10/02

(57) ABSTRACT

A vehicle is allocated to a user when a first predictor is detected, the first predictor being a predictor indicating that the user is to go out from a predetermined location. At this time, a control unit of an information processing device sends, to the user, a notification for confirming whether the user needs the vehicle at the time when a second predictor is detected, the second predictor being a predictor indicating that the user is to go out from the predetermined location and being a predictor other than the first predictor.

### CROSS-REFERENCE TO RELATED APPLICATION

This application claims priority to Japanese Patent Application No. 2020-192862 filed on Nov. 19, 2020, incorporated herein by reference in its entirety.

### BACKGROUND

### 1. Technical Field

The present disclosure relates to a technique (an information processing device, an information processing method and a system) for allocating a vehicle to a user.

### 2. Description of Related Art

Japanese Unexamined Patent Application Publication No. 2007-072784 (JP 2007-072784 A) discloses a vehicle allocation management system. The vehicle allocation management system disclosed in JP 2007-072784 A predicts demand for vehicle allocation a predetermined time before the end time of an event held in a business area. Then, information on the predicted demand is transmitted to a vehicle.

### SUMMARY

The present disclosure allocates a vehicle more suitably to a user that needs the vehicle to go out.

A first aspect of the present disclosure provides an information processing device including a control unit configured to execute, when a first predictor is detected based on user data related to an action by a user who is present at a predetermined location and a vehicle is allocated to the user, transmitting a notification for confirming whether the user needs the vehicle to the user at a time when a second predictor is detected, the first predictor being a predictor indicating that the user is to go out from the predetermined location, and the second predictor being a predictor indicating that the user is to go out from the predetermined location and being a predictor other than the first predictor.

A second aspect of the present disclosure provides an information processing method executed by a computer, the information processing method including transmitting, when a first predictor is detected based on user data related to an action by a user who is present at a predetermined location and a vehicle is allocated to the user, a notification for confirming whether the user needs the vehicle to the user at a time when a second predictor is detected, the first predictor being a predictor indicating that the user is to go out from the predetermined location, and the second predictor being a predictor indicating that the user is to go out from the predetermined location and being a predictor other than the first predictor.

A third aspect of the present disclosure provides a system including a sensor installed at a predetermined location at which a user is supposed to be present, a user terminal associated with the user, and an information processing device configured to manage operation of a vehicle, in which the information processing device is configured to execute: receiving, from the sensor, user data related to an action by the user who is present at the predetermined location; transmitting an operation instruction to allocate the vehicle to the user when a first predictor is detected based on the user data, the first predictor being a predictor indicating that the user is to go out from the predetermined location; and transmitting, to the user terminal, notification information for confirming whether the user needs the vehicle at a time when a second predictor is detected based on the user data, the second predictor being a predictor indicating that the user is to go out from the predetermined location and being a predictor other than the first predictor.

With the present disclosure, it is possible to allocate a vehicle more suitably to a user that needs the vehicle to go out.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a schematic configuration of a vehicle allocation system according to an embodiment;

FIG. 2 is a block diagram schematically illustrating an example of a functional configuration of each of a management server and a user terminal;

FIG. 3 is a diagram illustrating an example of a table configuration for an operation instruction;

FIG. 4 is a diagram illustrating an example of a table configuration for notification information;

FIG. 5 is a sequence diagram illustrating a flow of information processing performed by the vehicle allocation system;

FIG. 6 is a diagram illustrating an example of a table configuration for a predictor database; and

FIG. 7 is a flowchart illustrating a flow of a first user determination process.

### DETAILED DESCRIPTION OF EMBODIMENTS

When a predictor indicates that a user who is present at a predetermined location is to go out from the predetermined location (a predictor indicating that the user is to go out) and a vehicle is allocated to the user, the user can use the vehicle when the user actually goes out. However, the user occasionally does not actually go out even when the predictor indicates that the user is to go out. In addition, the user occasionally does not need the vehicle even when the predictor indicates that the user is to go out and the user actually goes out.

Thus, an information processing device according to an embodiment of the present disclosure confirms whether the user needs the vehicle to go out after the vehicle is allocated to the user. More particularly, the vehicle is allocated to the user who is present at the predetermined location when a first predictor is detected for the user, the predictor indicating that the user is to go out. The first predictor is detected based on user data related to an action by the user who is present at the predetermined location. When the vehicle is allocated to the user, the vehicle travels toward the predetermined location at which the user is still present.

When the first predictor is detected and the vehicle is allocated to the user, a control unit of the information processing device sends the user a notification for confirming whether the user needs the vehicle at the time when a second predictor is detected. The second predictor is a predictor that indicates the user is to go out and is other than the first predictor, which is detected for the user based on the user data.

Consequently, it is possible to confirm whether the user needs the vehicle to go out when the second predictor is detected. Therefore, the allocation of the vehicle to the user who has received the notification can be canceled when a response indicating that the user does not need the vehicle is received from the user. Thus, the vehicle is allocated to the user only when the user actually needs the vehicle to go out. In other words, it is possible to suppress the possibility that the vehicle is allocated to the user who actually does not need the vehicle. In addition, the vehicle can be allocated to the user more immediately when the user actually needs the vehicle, by allocating the vehicle to the user at the stage when the first predictor is detected. Thus, the information processing device according to the embodiment of the present disclosure can allocate the vehicle more suitably to the user who needs the vehicle to go out.

A specific embodiment of the present disclosure will be described below with reference to the drawings. Dimensions, material, shape, relative arrangement, etc. of constituent components described in relation to the embodiment are not intended to limit the technical scope of the present disclosure unless specifically stated otherwise.

### First Embodiment

System Overview

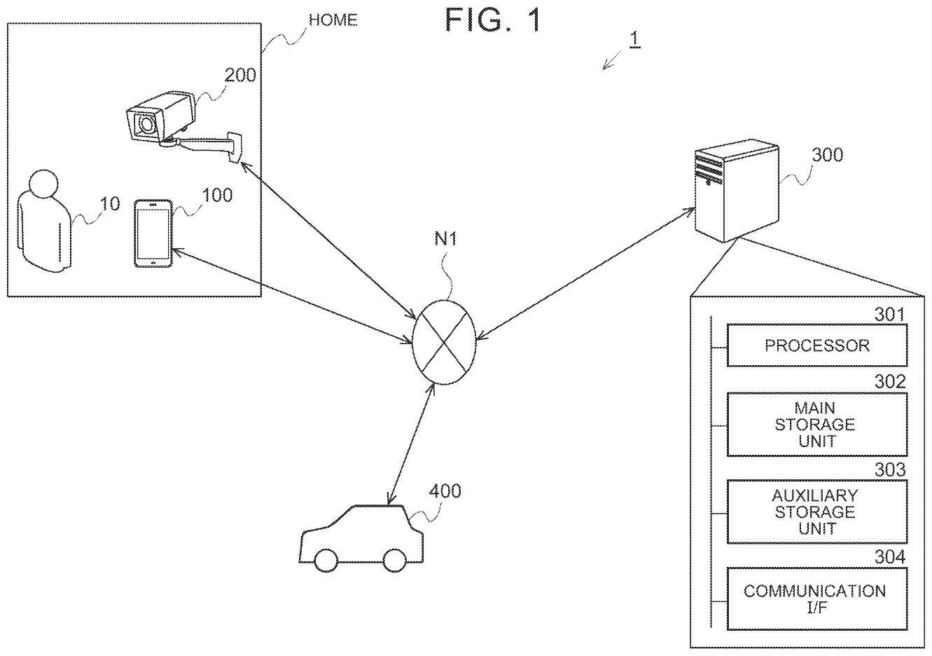

FIG. 1 is a diagram illustrating a schematic configuration of a vehicle allocation system according to an embodiment. The vehicle allocation system is a system that allocates a vehicle to a user who goes out. A vehicle allocation system 1 is configured to include a user terminal 100, a camera 200, a management server 300, and a vehicle 400. In the vehicle allocation system 1, the user terminal 100, the camera 200, the management server 300, and the vehicle 400 are connected to each other through a network N1. The network N1 may be a Wide Area Network (WAN) that is a worldwide public communication network such as the Internet, or a telephone communication network such as cellular phones, for example.

In the embodiment, a user 10 is present in his/her home. In the embodiment, the home of the user 10 can be regarded as a “predetermined location” according to the present disclosure. When a predictor indicating that the user 10 is to go out is detected, the vehicle allocation system 1 allocates the vehicle 400 to the user 10 such that the user 10 can use the vehicle 400 when the user 10 goes out. However, the “predetermined location” according to the present disclosure is not limited to the home of the user. For example, the “predetermined location” according to the present disclosure may be a workplace of the user.

The camera 200 is installed in the home of the user 10. The camera 200 captures an image including the user 10 in the home. The image captured by the camera 200 may be either a still image or a moving image. The image data captured by the camera 200 are transmitted to the management server 300 via the network N1. In the embodiment, the camera 200 can be regarded as a “sensor” according to the present disclosure.

The management server 300 is a server device that manages operation of the vehicle 400. The management server 300 is configured to include a general computer. The computer that constitutes the management server 300 includes a processor 301, a main storage unit 302, an auxiliary storage unit 303, and a communication interface (communication I/F) 304.

The processor 301 is a central processing unit (CPU) or a digital signal processor (DSP), for example. The main storage unit 302 is a random access memory (RAM), for example. The auxiliary storage unit 303 is a read only memory (ROM), a hard disk drive (HDD), or a flash memory, for example. The auxiliary storage unit 303 may also include a removable medium (portable recording medium). The removable medium is a universal serial bus (USB) memory, a secure digital (SD) card, or a disk recording medium such as a compact disc read only memory (CD-ROM), a digital versatile disc (DVD), and a Blu-ray Disc, for example. The communication I/F 304 is a local area network (LAN) interface board or a wireless communication circuit for wireless communication, for example.

The auxiliary storage unit 303 stores an operating system (OS), various programs, various information tables, etc. The processor 301 loads programs stored in the auxiliary storage unit 303 into the main storage unit 302 and executes the programs to implement control for allocation of the vehicle 400 as discussed later. However, some or all of the functions of the management server 300 may be implemented by a hardware circuit such as an application specific integrated circuit (ASIC) and a field programmable gate array (FPGA). The management server 300 is not necessarily implemented by a single physical component, and may be constituted by a plurality of computers that cooperates with each other. In the embodiment, the management server 300 can be regarded as the “information processing device” according to the present disclosure.

The management server 300 receives the image data transmitted from the camera 200 as user data related to the action by the user 10 who is present in the home. Then, the management server 300 detects, based on the image data received from the camera 200, the first predictor that is a predictor indicating that the user 10 is to go out from the home (the predictor indicating that the use is to go out).

In addition, the management server 300 also allocates the vehicle 400 to the user 10 when the first predictor is detected. Particularly, the management server 300 transmits, to the vehicle 400, an operation instruction to travel toward the home of the user 10 via the network N1. The vehicle 400 is an autonomous driving vehicle that can travel autonomously. The vehicle 400 travels based on the operation instruction received from the management server 300. Therefore, the vehicle 400 travels toward the home of the user 10 when the operation instruction to travel toward the home of the user 10 is received.

Further, the management server 300 sends a notification for confirming whether the user 10 needs the vehicle 400 to the user 10 at a predetermined timing after the operation instruction is transmitted to the vehicle 400. The predetermined timing is a timing when the second predictor is detected based on the image data received from the camera 200. The second predictor indicates that the user 10 is to go out and is other than the first predictor. When the second predictor is detected, the management server 300 transmits notification information for confirming whether the user 10 needs the vehicle 400 to the user terminal 100 via the network.

The user terminal 100 is a terminal possessed by the user 10. Examples of the user terminal 100 include a smartphone, a tablet computer, and a wearable terminal. The user 10 can understand that the vehicle 400 has been allocated to the user 10 when the user terminal 100 receives the notification information transmitted from the management server 300. Then, the user 10 responds that the user 10 does not need the vehicle 400 when the user 10 actually does not go out or when the user 10 does not need the vehicle 400 even when the user 10 actually goes out. In this case, the user terminal 100 transmits response information indicating that the user 10 does not need the vehicle to the management server 300 via the network N1.

When the response information indicating that the user 10 does not need the vehicle is received from the user terminal 100, the management server 300 cancels the allocation of the vehicle 400 to the user 10. In this case, when the vehicle 400 is moving toward the home of the user 10, the management server 300 transmits a cancellation instruction to cancel travel toward the home of the user 10 to the vehicle 400 via the network N1. When the cancellation instruction is received from the management server 300, the vehicle 400 cancels the travel toward the home of the user 10 that has been made based on the operation instruction. As a result, the allocation of the vehicle 400 to the user 10 is canceled.

Functional Configuration

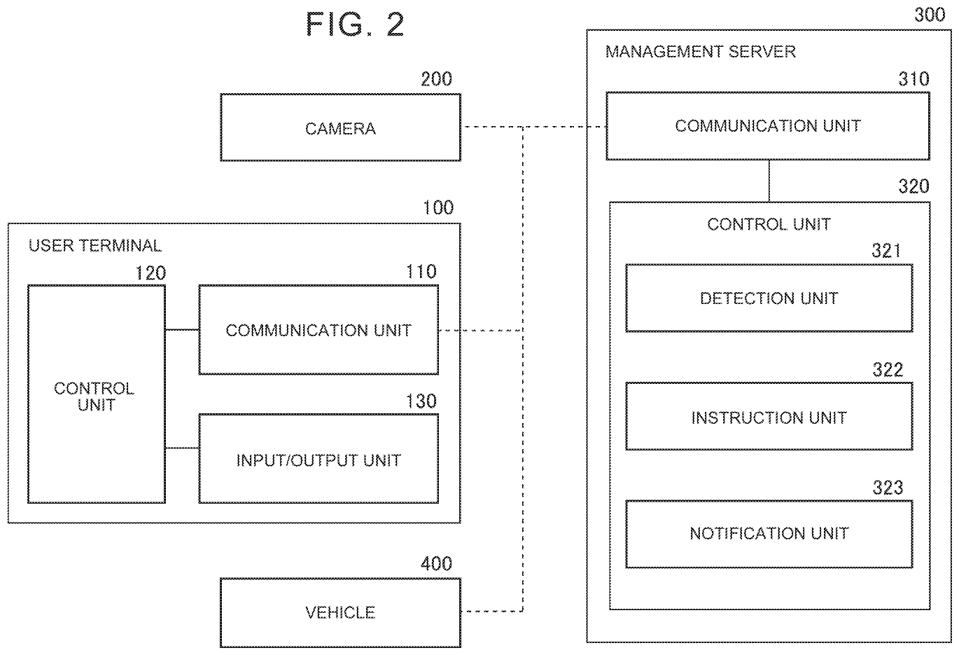

Next, the functional configuration of the management server 300 and the user terminal 100 that constitute the vehicle allocation system 1 will be described with reference to FIG. 2. FIG. 2 is a block diagram schematically illustrating an example of a functional configuration of each of the management server 300 and the user terminal 100.

Management Server

The management server 300 includes a communication unit 310 and a control unit 320. The communication unit 310 has a function of connecting the management server 300 to the network N1. The communication unit 310 can be implemented by the communication I/F 304. The control unit 320 has a function of performing a computation process for controlling the management server 300. The control unit 320 can be implemented by the processor 301. The control unit 320 performs a process of receiving the image data transmitted from the camera 200 using the communication unit 310.

The control unit 320 includes a detection unit 321, an instruction unit 322, and a notification unit 323 as functional units. The detection unit 321 has a function of detecting a predictor indicating that the user 10 is to go out based on the image data received from the camera 200. Particularly, the detection unit 321 extracts the action by the user 10 in the home from the image data. When the extracted action by the user 10 is an action performed before going out, the detection unit 321 detects the action by the user 10 as a predictor indicating that the user 10 is to go out.

Any method that is known in the art may be adopted as a method of determining whether the actions by the user 10 extracted from the image data are the “actions performed before going out”. For example, a plurality of types of predetermined actions may be determined in advance as the “actions performed before going out”. In this case, examples of the predetermined actions may include “change to clothes for going out”, “make-up”, etc. Examples of the predetermined actions that may be detected as the second predictor can include actions performed at the entrance of the home such as “wearing shoes”. Then, the detection unit 321 may determine whether the actions by the user 10 extracted from the image data are the predetermined actions. When the user 10 actually goes out from the home, the management server 300 may store the actions performed by the user 10 before going out as history information in a database. Then, the detection unit 321 may determine whether the actions by the user 10 extracted from the image data are the “actions performed before going out” based on the history information stored in the database.

The instruction unit 322 has a function of generating an operation instruction for the vehicle 400, and transmitting the generated operation instruction to the vehicle 400. When the first predictor for the user 10 is detected by the detection unit 321, the instruction unit 322 generates an operation instruction to cause the vehicle 400 to travel toward the home of the user 10. Then, the instruction unit 322 transmits the operation instruction to the vehicle 400 using the communication unit 310.

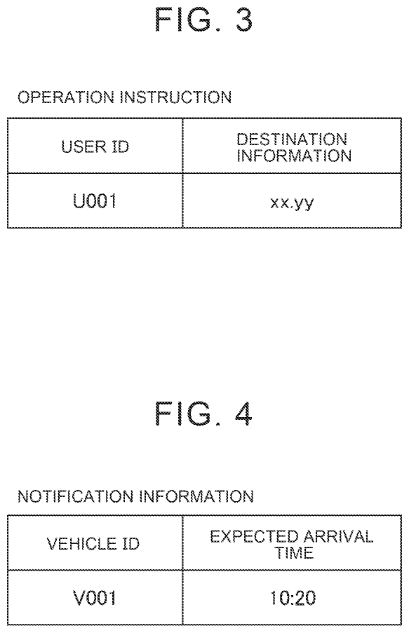

FIG. 3 is a diagram illustrating an example of a table configuration for the operation instruction to be transmitted to the vehicle 400 by the instruction unit 322. As illustrated in FIG. 3, the operation instruction includes a user identification (ID) field and a destination information field. A user ID that is identification information for specifying the user 10 is input to the user ID field. Information that indicates the position of the home of the user 10 is input to the destination information field. When the operation instruction transmitted by the instruction unit 322 is received, the vehicle 400 travels toward the home of the user 10 based on destination information included in the operation instruction.

In addition, the control unit 320 performs a process of receiving the response information that is transmitted from the user terminal 100 and that indicates that the user 10 does not need a vehicle, using the communication unit 310, as discussed later. When such response information is received, the instruction unit 322 transmits a cancellation instruction to cancel the travel toward the home of the user 10 to the vehicle 400 using the communication unit 310.

The notification unit 323 has a function of generating notification information for confirming whether the user 10 needs the vehicle 400, and transmitting the generated notification information to the user terminal 100. When the second predictor for the user 10 is detected by the detection unit 321 after the operation instruction is transmitted to the vehicle 400 by the instruction unit 322, the notification unit 323 generates notification information. Then, the notification unit 323 transmits the notification information to the user terminal 100 using the communication unit 310.

FIG. 4 is a diagram illustrating an example of a table configuration for the notification information to be transmitted to the user terminal 100 by the notification unit 323. As illustrated in FIG. 4, the notification information includes a vehicle ID field and an expected arrival time field. A vehicle ID that is identification information for specifying the vehicle 400 is input to the vehicle ID field. An expected arrival time at which the vehicle 400 is expected to arrive at the home of the user 10 is input to the expected arrival time field. The expected arrival time can be estimated based on the present position of the vehicle 400 and the position of the home of the user 10. At this time, the expected arrival time may be estimated in consideration of the traffic condition in a route from the vehicle 400 to the home of the user 10.

User Terminal

The user terminal 100 includes a communication unit 110, a control unit 120, and an input/output unit 130. The communication unit 110 has a function of connecting the user terminal 100 to the network N1. The communication unit 110 can be implemented by a communication interface of the user terminal 100. The communication unit 110 can communicate with other devices including the management server 300 via the network N1 using a mobile communication service such as 3rd Generation (3G) and Long Term Evolution (LTE), for example.

The control unit 120 has a function of performing a computation process for controlling the user terminal 100. The control unit 120 can be implemented by a processor of the user terminal 100. The control unit 120 performs a process of receiving the notification information transmitted from the management server 300 using the communication unit 110.

The input/output unit 130 has a function of receiving an input operation performed by the user 10, and a function of outputting information to be presented to the user 10. For example, the input/output unit 130 is configured to include a touch panel display. When the notification information is received from the management server 300, the control unit 120 outputs the notification information using the input/output unit 130. Consequently, the user 10 is notified that the vehicle 400 has been allocated to the user 10. In addition, as discussed above, the expected arrival time at which the vehicle 400 is expected to arrive at the home of the user 10 is included in the notification information. Therefore, the user 10 can determine whether the user 10 needs the vehicle 400 in consideration of the expected arrival time at which the vehicle 400 is expected to arrive at the home.

When the vehicle 400 is not needed, the user 10 inputs a response indicating that the vehicle 400 is not needed to the user terminal 100 via the input/output unit 130. When such a response is input by the user 10, the control unit 120 performs a process of transmitting the response information indicating that the user 10 does not need the vehicle to the management server 300 using the communication unit 110.

Flow of Information Processing

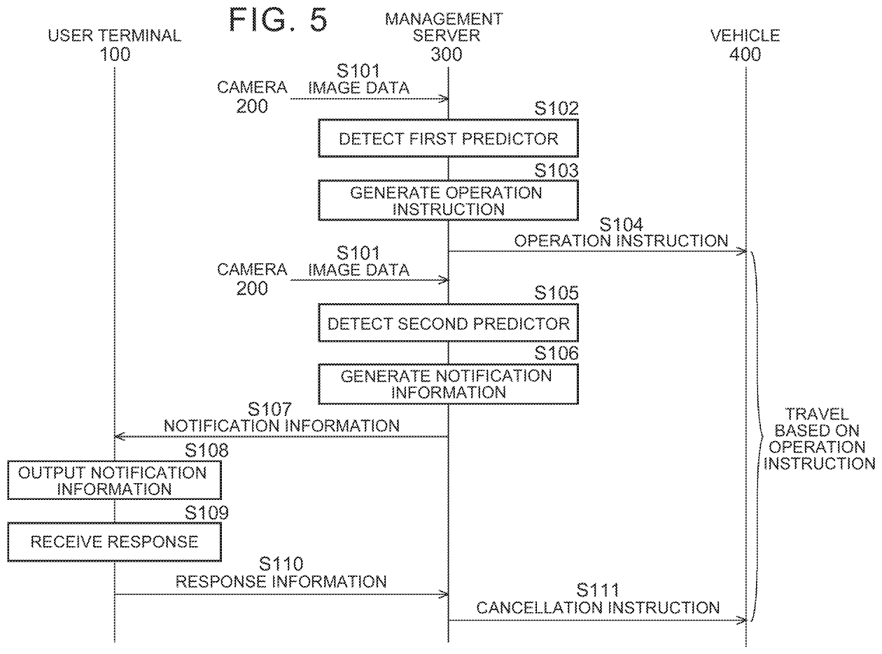

Next, the flow of information processing performed by the vehicle allocation system 1 will be described with reference to FIG. 5. FIG. 5 is a sequence diagram illustrating a flow of information processing performed by the vehicle allocation system 1. FIG. 5 illustrates the flow of information processing for a case where the user 10 does not need the vehicle 400.

In the vehicle allocation system 1, the management server 300 continuously receives image data including the user 10 who is present in the home from the camera 200 (S101). Then, the management server 300 detects the first predictor for the user 10 based on the image data received from the camera 200 (S102). Next, the management server 300 generates an operation instruction to cause the vehicle 400 to travel toward the home of the user 10, and transmits the operation instruction to the vehicle 400 (S103 and S104). When the operation instruction is received from the management server 300, the vehicle 400 travels based on the operation instruction.

In addition, the management server 300 detects the second predictor for the user 10 based on the image data received from the camera 200 (S105). Next, the management server 300 generates notification information for confirming whether the user 10 needs the vehicle 400, and transmits the notification information to the user terminal 100 (S106 and S107).

When the notification information is received from the management server 300, the user terminal 100 outputs the notification information (S108). Then, the user terminal 100 receives a response input by the user 10 and indicating that the vehicle 400 is not needed (S109). Next, the user terminal 100 transmits the response information indicating that the user 10 does not need the vehicle to the management server 300 (S110). When the response information is received from the user terminal 100, the management server 300 transmits a cancellation instruction to cancel the travel toward the home of the user 10 to the vehicle 400 (S111). Consequently, the vehicle 400 cancels the travel, the destination of which is the home of the user 10 and which is based on the operation instruction.

When the user 10 uses the vehicle 400 to go out, the response information indicating that the user 10 does not need the vehicle is not transmitted from the user terminal 100 to the management server 300. In this case, the cancellation instruction is not transmitted from the management server 300 to the vehicle 400. Therefore, the vehicle 400 continues the travel based on the operation instruction until the vehicle 400 arrives at the home of the user 10. Meanwhile, the vehicle 400 occasionally has already arrived at the home of the user 10 when the management server 300 receives the response information indicating that the user 10 does not need the vehicle from the user terminal 100 in S110. In this case, the management server 300 may transmit, to the vehicle 400, a movement instruction to move from the home of the user 10. The second predictor detected in S105 is not necessarily a predictor indicating that the user 10 is to go out, which is detected in continuation of the first predictor detected in S102. For example, the action by the user 10 detected as the second predictor may be limited to an action performed at the entrance of the home such as that described above.

With the vehicle allocation system 1 described above, the vehicle 400 is allocated to the user 10 only when the user 10 actually needs the vehicle 400 to go out. In other words, it is possible to suppress the possibility that the vehicle 400 is allocated to the user 10 who actually does not need the vehicle 400. With the vehicle allocation system 1, in addition, the vehicle 400 is allocated to the user 10 at the stage when the first predictor for the user 10 is detected. Therefore, it is possible to allocate the vehicle 400 to the user 10 more immediately when the user 10 actually needs the vehicle 400.

### First Modification

A modification of the vehicle allocation system 1 according to the present embodiment will be described below. In the embodiment described above, the management server 300 receives the image data transmitted from the camera 200 as user data related to the action by the user 10 in the home. However, the user data are not limited to the image data. For example, actions performed by the user 10 can be estimated based on the position of the user 10 in the home or the transition of the position (i.e. the movement path of the user 10 in the home). Thus, the management server 300 may receive data that indicate the position of the user 10 in the home as the user data. The position of the user 10 in the home may be detected using human detection sensors etc. installed at a plurality of locations in the home. Then, the detection unit 321 of the management server 300 may detect a predictor indicating that the user 10 is to go out based on the position of the user 10 in the home or the transition of the position.

### Second Modification

In the embodiment described above, the detection unit 321 of the management server 300 detects a predictor indicating that the user 10 is to go out based on the image data transmitted from the camera 200. However, the camera 200 may have a function corresponding to the detection unit 321 of the management server 300. In this case, the camera 200 detects a predictor indicating that the user 10 is to go out based on the captured image data. Then, information indicating that the predictor for the user 10 has been detected is transmitted from the camera 200 to the management server 300. When the information indicating that the first predictor for the user 10 has been detected is received from the camera 200, the management server 300 transmits an operation instruction to the vehicle 400. When information indicating that the second predictor for the user 10 has been detected is received from the camera 200, in addition, the management server 300 transmits notification information to the user terminal 100.

### Second Embodiment

In the embodiment, a plurality of users 10 is present in their respective homes. Then, in the vehicle allocation system 1, image data on each of the users 10 are transmitted from the camera 200 installed in the home of the user 10 to the management server 300. Meanwhile, the detection unit 321 of the management server 300 detects a predictor indicating that each user 10 is to go out based on the image data received from each camera 200.

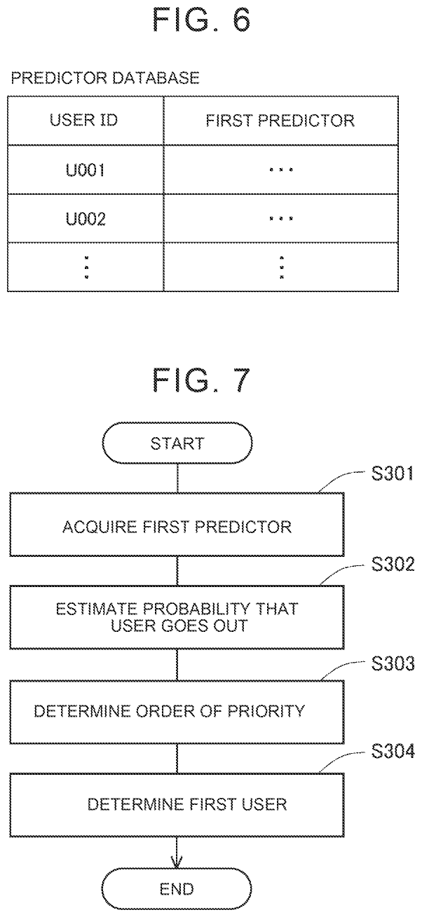

When a first predictor is detected for the plurality of users 10, the control unit 320 of the management server 300 stores the first predictor for each of the users 10 in a database (hereinafter occasionally referred to as a “predictor database”). FIG. 6 is a diagram illustrating an example of a table configuration for the predictor database. As illustrated in FIG. 6, the predictor database includes a user ID field and a first predictor field. A user ID that is identification information for specifying each user 10 is input to the user ID field. The first predictor for each user 10 detected by the detection unit 321 is input to the first predictor field. That is, an action by each user 10 in the home detected as the first predictor is input to the first predictor field. The predictor database is built in the auxiliary storage unit 303 of the management server 300 by the processor 301 executing a program of a database management system.

Further, the control unit 320 determines the order of priority for vehicle allocation based on the first predictor for each user 10. Then, the control unit 320 allocates the vehicle 400 to a first user whose order of priority for vehicle allocation is the highest among the plurality of users 10. That is, the instruction unit 322 of the control unit 320 generates an operation instruction to cause the vehicle 400 to travel toward the home of the first user, and transmits the operation instruction to the vehicle 400.

First User Determination Process

The flow of a first user determination process according to the embodiment will be described with reference to FIG. 7. FIG. 7 is a flowchart illustrating a flow of the first user determination process. The first user determination process is executed by the control unit 320 of the management server 300. The first user determination process is executed with the first predictor for each of the users 10 stored in the predictor database.

In this flow, first, in S301, the first predictor for each user 10 stored in the predictor database is acquired. Next, in S302, a probability that each user 10 goes out is estimated based on the first predictor acquired in S301. The probability that each user 10 goes out is a probability that the user 10 actually goes out from the home. Various actions by each user 10 in the home are detected as the first predictor for the user 10. The probability that the user 10 goes out differs in accordance with a type of action by the user 10 in the home detected as the first predictor. Thus, in S302, the control unit 320 estimates the probability that each user 10 goes out based on the type of action by the user 10 in the home detected as the first predictor. The management server 300 may store in advance the relationship between the type of action by the user 10 in the home detected as the first predictor and the probability that the user 10 goes out.

Next, in S303, the order of priority for vehicle allocation is determined based on the probability that each user 10 goes out. The probability is estimated in S302. As the probability that the user 10 goes out is higher, the order of priority for vehicle allocation to the user 10 is determined to be higher. Next, in S304, the user 10 whose order of priority for vehicle allocation determined in S303 is the highest is determined as the first user.

Change of Vehicle Allocation Destination

In the present embodiment, as described above, the management server 300 allocates the vehicle 400 to the first user whose order of priority for vehicle allocation is the highest among the plurality of users 10. Then, the management server 300 transmits notification information to the user terminal 100 of the first user. At this time, there may be a case where the first user does not need the vehicle 400. In this case, the management server 300 receives response information indicating that the first user does not need the vehicle from the user terminal 100 of the first user.

When the response information indicating that the first user does not need the vehicle is received, the management server 300 cancels the travel of the vehicle 400 toward the home of the first user. Then, the destination to which the vehicle 400 is allocated is changed to a user other than the first user, among the plurality of users 10, by the management server 300. At this time, the management server 300 transmits, to the vehicle 400, an operation instruction to cause the vehicle 400 to travel toward the user determined as a new destination of vehicle allocation.

When the destination to which the vehicle 400 is allocated is changed to a user other than the first user, the management server 300 may determine, as the new destination of vehicle allocation, a user whose order of priority for vehicle allocation is the second highest to the first user, among the plurality of users 10. Alternatively, the management server 300 may determine the new destination to which the vehicle 400 is allocated based on the position of the vehicle 400 at the time when response information indicating that the first user does not need the vehicle is received. That is, a user whose home is the closest to the position of the vehicle 400 at the time when the management server 300 receives the response information, among the plurality of users 10 other than the first user, may be determined as the new destination of vehicle allocation.

With the vehicle allocation system 1 according to the embodiment, the vehicle 400 can be allocated effectively even when a predictor indicating that each of the users 10 is to go out is detected.

Modification

In the embodiment described above, the order of priority for vehicle allocation is determined based on the probability indicating that each user 10 goes out in the first user determination process. However, the method of determining the order of priority for vehicle allocation is not limited thereto. For example, the control unit 320 of the management server 300 may determine the order of priority for vehicle allocation based on the time when each user 10 goes out. In this case, the time when each user 10 goes out from the home is estimated based on the first predictor for the user 10 stored in the predictor database. The time when the user 10 goes out differs in accordance with the type of action by the user 10 in the home detected as the first predictor. Thus, the control unit 320 estimates the time when each user 10 goes out based on the type of action by the user 10 in the home detected as the first predictor. The management server 300 may store in advance the relationship between the type of action by the user 10 in the home detected as the first predictor and the time when the user 10 goes out. The control unit 320 may determine that the order of priority for vehicle allocation to the user 10 is higher as the time when the user 10 goes out is earlier.

In the vehicle allocation system 1 according to the first and second embodiments described above, the vehicle 400 is an autonomous driving vehicle. However, the vehicle to be allocated to the user 10 may not necessarily be an autonomous driving vehicle. That is, the vehicle to be allocated to the user 10 may be a vehicle driven by a driver. In this case, an instruction to allocate the vehicle to the user and an instruction to cancel the allocation of the vehicle to the user are transmitted from the management server 300 to a terminal associated with the driver (e.g. a terminal possessed by the driver).

### OTHER EMBODIMENTS

The embodiments described above are merely examples, and the present disclosure may be modified as appropriate and implemented without departing from the scope and spirit of the present disclosure. In addition, the processes and the structure described in relation to the present disclosure may be combined freely and implemented unless any technical contradiction occurs.

In addition, a process described as being performed by a single device may be executed in a shared manner by a plurality of devices. Conversely, a process described as being performed by different devices may be executed by a single device. Types of hardware configurations (server configurations) of a computer system that are used to implement the various functions are changeable flexibly.

The present disclosure can also be implemented by supplying a computer program that implements the functions described in relation to the above embodiments to a computer, and causing one or more processors included in the computer to read and execute the program. Such a computer program may be provided to the computer through a non-transitory computer-readable storage medium that is connectable to a system bus of the computer, or may be provided to the computer via a network. Examples of the non-transitory computer-readable storage medium include a disk of any type such as a magnetic disk (such as a floppy (registered trademark) disk and a hard disk drive (HDD)) and an optical disk (such as a CD-ROM, a DVD, and a Blu-ray Disc), and a medium of any type that is suitable for storing an electronic instruction, such as a read only memory (ROM), a random access memory (RAM), an erasable programmable read only memory (EPROM), an electrically erasable programmable read only memory (EEPROM), a magnetic card, a flash memory, and an optical card.

What is claimed is:

1. An information processing device comprising a control unit configured to execute, when a first predictor is detected based on user data related to an action by a user who is present at a predetermined location and a vehicle is allocated to the user, transmitting a notification for confirming whether the user needs the vehicle to the user at a time when a second predictor is detected, the first predictor being a predictor indicating that the user is to go out from the predetermined location, and the second predictor being a predictor indicating that the user is to go out from the predetermined location and being a predictor other than the first predictor.

2. The information processing device according to claim 1, wherein the control unit is configured to further execute canceling allocation of the vehicle to the user when the control unit receives from the user a response indicating that the vehicle is not needed after transmitting the notification.

3. The information processing device according to claim 1, wherein the notification includes an expected arrival time at which the vehicle is expected to arrive at the predetermined location.

4. The information processing device according to claim 1, wherein the control unit is configured to:
further execute determining an order of priority for vehicle allocation based on the first predictor for a plurality of users, when the first predictor is detected for the users; and
allocate the vehicle to a first user whose order of priority for the vehicle allocation is the highest among the users.

5. The information processing device according to claim 4, wherein the control unit is configured to:
further execute estimating a probability that each of the users actually goes out, based on the first predictor for each of the users; and
determine the order of priority for the vehicle allocation based on the probability that each of the users actually goes out.

6. The information processing device according to claim 4, wherein the control unit is configured to:
further execute estimating a time when each of the users goes out, based on the first predictor for each of the users; and
determine the order of priority for the vehicle allocation based on the time when each of the users goes out.

7. The information processing device according to claim 4, wherein the control unit is configured to change a destination of allocation of the vehicle to a user other than the first user, among the users, when the control unit receives a response that the vehicle is not needed from the first user after transmitting the notification to the first user.

8. The information processing device according to claim 1, wherein the user data include image data that include the user and that are captured at the predetermined location.

9. The information processing device according to claim 1, wherein the user data include data that indicate a position of the user at the predetermined location.

10. An information processing method executed by a computer, the information processing method comprising transmitting, when a first predictor is detected based on user data related to an action by a user who is present at a predetermined location and a vehicle is allocated to the user, a notification for confirming whether the user needs the vehicle to the user at a time when a second predictor is detected, the first predictor being a predictor indicating that the user is to go out from the predetermined location, and the second predictor being a predictor indicating that the user is to go out from the predetermined location and being a predictor other than the first predictor.

11. The information processing method according to claim 10, further comprising further executing cancellation of allocation of the vehicle to the user when a control unit receives from the user a response indicating that the vehicle is not needed after transmitting the notification.

12. The information processing method according to claim 10, wherein the notification includes an expected arrival time at which the vehicle is expected to arrive at the predetermined location.

13. The information processing method according to claim 10, further comprising determining, when the first predictor is detected for a plurality of users, an order of priority for vehicle allocation based on the first predictor for each of the users, wherein the vehicle is allocated to a first user whose order of priority for the vehicle allocation is the highest among the users.

14. The information processing method according to claim 13, further comprising estimating a probability that each of the users actually goes out, based on the first predictor for each of the users, wherein the order of priority for the vehicle allocation is determined based on the probability that each of the users actually goes out.

15. The information processing method according to claim 13, further comprising estimating a time when each of the users goes out, based on the first predictor for each of the users, wherein the order of priority for the vehicle allocation is determined based on the time when each of the users goes out.

16. A system comprising a sensor installed at a predetermined location at which a user is supposed to be present, a user terminal associated with the user, and an information processing device configured to manage operation of a vehicle, wherein the information processing device is configured to execute:
receiving, from the sensor, user data related to an action by the user who is present at the predetermined location;
transmitting an operation instruction to allocate the vehicle to the user when a first predictor is detected based on the user data, the first predictor being a predictor indicating that the user is to go out from the predetermined location; and
transmitting, to the user terminal, notification information for confirming whether the user needs the vehicle at a time when a second predictor is detected based on the user data, the second predictor being a predictor indicating that the user is to go out from the predetermined location and being a predictor other than the first predictor.

17. The system according to claim 16, wherein the information processing device is configured to further execute transmitting a cancellation instruction to cancel allocation of the vehicle to the user when response information indicating that the vehicle is not needed is received from the user terminal.

18. The system according to claim 16, wherein the information processing device is configured to:
further execute determining an order of priority for vehicle allocation based on the first predictor for a plurality of users when the first predictor is detected for each of the users; and
transmit the operation instruction to allocate the vehicle to a first user whose order of priority for the vehicle allocation is the highest among the users.

19. The system according to claim 18, wherein the information processing device is configured to:
further execute estimating a probability that each of the users actually goes out, based on the first predictor for each of the users; and
determine the order of priority for the vehicle allocation based on the probability that each of the users actually goes out.

20. The system according to claim 18, wherein the information processing device is configured to:
further execute estimating a time when each of the users goes out, based on the first predictor for each of the users; and
determine the order of priority for the vehicle allocation based on the time when each of the users goes out.
